(19) United States
(12) Patent Application Publication
(10) Pub. No.: US 2026/0355819 A2
(43) Pub. Date: Nov. 12, 2026

(54) ETCHLESS METAL PLATING USING COLD SINTERING

(71) Applicant: SABIC Global Technologies B.V., Bergen op Zoom (ND)

(72) Inventors: Sara Ali Abbas, Bangalore (IN); Saeed Omar Badahdah, Bangalore (IN); Donald Owens, Bangalore (IN); Amit Kumar Tevtia, Bangalore (IN); Karina Katarzyna Kopec, Bangalore (IN)

(21) Appl. No.: 18/555,688

(22) PCT Filed: Apr. 18, 2022
(86) PCT No.: PCT/EP2022/060205

§ 371 Date: Oct. 16, 2023

(30) Foreign Application Priority Data
Apr. 19, 2021 (EP) 21169256.1

(51) Int. Cl. B22F 3/02; B22F 3/24; B22F 7/02

(52) U.S. Cl. CPC B22F 3/02; B22F 3/24; B22F 7/02; B22F 2003/242; B22F 2998/10

(57) ABSTRACT

The present application describes the development of a method for creating a continuous conductive metal layer on a surface of a component, the component preferably made of molded acrylonitrile butadiene styrene polymer (ABS) or polycarbonate/ABS (PC/ABS) blend, the method utilizing cold sintering. This method avoids the need for chromic acid etching pretreatment prior to the electroplating process. Continuous, conductive and thickness-controllable layers of metals such as Ni, Fe, Cu or Ni/Fe have been created on the plastic surface using the cold sintering. The method will also work with any other metal. Thus, molded ABS or PC/ABS parts can be further electroplated without the need to go through the undesirable etching process.

### CROSS REFERENCE TO RELATED APPLICATIONS

This application is a National Stage Application under 35 U.S.C. § 371 and claims the benefit of International Application No. PCT/EP 2022/060205, filed Apr. 18, 2022, which claims priority to EP 21169256.1, filed Apr. 19, 2021, the contents of both of which are incorporated herein in their respective entirety.

### TECHNICAL FIELD

The present disclosure is directed to the field of metal plating of polymer components.

### BACKGROUND

Polymer blends of polycarbonate (“PC”) with acrylonitrile butadiene styrene (“ABS”), as well as ABS molded resins are metallized and used in many automotive applications. These materials can be made with a mirror finish to resemble metal parts while providing light weighting benefits. Additionally, the metal coatings can also improve the underlying polymer's mechanical strength, thermal and environmental stability and chemical resistance. Conventional electroplated metal coatings do not bond or adhere to plastic or elastomeric materials unless the surfaces of these materials are first suitably prepared. A common treatment can include chemically etching the surface with solutions containing chromium trioxide or mixed acid combinations such as chromic/sulfuric or chromic/sulfuric/phosphoric acids types. These strongly oxidizing solutions micro-roughen and chemically alter the surface of the polymer materials by forming polar organic functional groups such as R—COOH, R—OH, R—SO₃ and R—CH═O. The presence of these polar groups promotes the adsorption of plating catalysts from aqueous solutions that allows subsequent metal deposition to readily occur. FIG. 1 shows a typical sequence of steps in such a process.

There are two main disadvantages of using solutions containing chromium trioxide. First, this chemical is rated as a human carcinogenic material, and secondly, disposal of these used acid solutions is difficult and costly. A further disadvantage relates to the removal and detoxification of hexavalent chromium compounds from the etched plastic parts. Upon etch treatment, chromic acid residues remaining on the polymer surface can inhibit electroless deposition, and it can be difficult to fully remove. In an effort to avoid these problems, alternative processes to chromic acid etching have been sought in the past. Dry plasma etching processes could be an alternative for the wet etching one as it has the ability to activate the surface chemically and physically. However, this method is only applied on the molded parts, and requires manufacturers to invest in expensive and complex equipment.

In the past many different processes have been tested to replace chromic acid with other oxidizing agents. One material proposed for replacing chromic acid is potassium permanganate, and the use of alkali permanganate solutions, has been investigated as a possible alternative to chromic acid etching. Hot alkaline permanganate solutions have seen some commercial success, but their success has been generally limited to treating printed circuit boards. The biggest issue with potassium permanganate is its slower oxidizing rate compared to chromic acid, which reduces drastically the number of plated parts per unit time as an outcome. These systems typically require higher loadings of expensive sensitizer and catalyst materials (SnCl₂ and Pd) to achieve equivalent plating quality.

Additionally, various prior art attempts have been made to blend polycarbonate resins with other polymeric modifiers, to achieve various desired benefits. For example, an epoxy functionalized polybutene may be blended into the polycarbonate/ABS blends. More particularly, such a blend may comprise one or more polycarbonate resins, one or more grafted ABS resins, a rigid SAN polymer and an effective amount of aliphatic C4 to C16 poly-alpha-olefin, functionalized aliphatic poly-alpha-olefin polymer or a hydrogenated poly-alpha-olefin.

In another prior approach, methacrylate butadiene styrene (MBS) and polypropylene-graft-maleic anhydride (PP-g-MA) were added as a single compatibilizer in polycarbonate/poly(acrylonitrile-butadiene-styrene) blends (PC/ABS). Results indicated that MBS exhibited higher tensile strength, hardness, and density, whereas PP-g-MA was a more effective compatibilizer for the PC/ABS 70/30 wt. % blend than MBS. Prior art teaches such compatibilizers must have relatively low molecular weights so as to stay uniformly mixed in the final blend during melting and molding.

Therefore, what is needed is an improved method of metal-plating that does not require any etching steps (dry or wet) to activate the surface.

### BRIEF SUMMARY

The present application describes the development of a method for creating a continuous conductive metal layer on a surface of a component, the component preferably made of molded acrylonitrile butadiene styrene polymer (ABS) or polycarbonate/ABS (PC/ABS) blend, the method utilizing cold sintering. This method avoids the need for chromic acid etching pretreatment prior to the electroplating process. Continuous, conductive and thickness-controllable layers of metals such as Ni, Fe, Cu or Ni/Fe have been created on the plastic surface using the cold sintering. The method will also work with any other metal. Thus, molded ABS or PC/ABS parts can be further electroplated without the need to go through the undesirable etching process.

Disclosed is a method of preparing a component suitable for metal plating, the method comprising (a) cold sintering metal powder to create a first portion of a component, (b) adding plastic to at least one surface of the first portion, and (c) cold sintering the plastic onto the first portion, the plastic being a second portion of the component. The shape of the first portion is preferably defined by a mold. The plastic that is added is preferably in a powdered form. The sintering steps are preferably performed using a hydraulic press, a heat jacket and a temperature controller. The applied temperature is preferably in the range of 140 to 200 °C, the time is preferably in the range of 1 to 2 hours, and the pressure is preferably in the range of 300 to 400 MPa. The powdered metal is preferably primarily nickel, copper, iron, or a mixture thereof of two or more of nickel, copper and iron. The plastic is preferably at least partially polycarbonate. The plastic is preferably at least partially acrylonitrile butadiene styrene (ABS). The method preferably does not include any additional binders. The method may preferably comprise an additional step of plating an additional metal onto the component, without etching, sensitization or activation steps. The additional metal is preferably gold, silver, chrome, nickel, copper, nickel bright, copper bright, or mixture thereof of two or more of these metals. The plastic preferably includes thermal stabilizers. The plastic preferably includes a lubricant or mold release. The plastic includes an acid scavenger. The plastic includes one or more impact enhancers. The component is preferably used in the automotive and electronics industry. The plastic preferably includes one or more pigments and/or dyes.

Disclosed as well is a composition for a component, the component comprising about 95% of a non-ABS plastic, 4% ABS, and 1% metal, the metal being on the surface of the component. The metals are preferably nickel, copper, iron, or a mixture thereof of two or more of nickel, copper and iron. The plastic is preferably at least partially polycarbonate.

Other objects, features and advantages of the present disclosure will become apparent from the following figures, detailed description, and examples. It should be understood, however, that the figures, detailed description, and examples, while indicating specific embodiments of the disclosure, are given by way of illustration only and are not meant to be limiting. Additionally, it is contemplated that changes and modifications within the spirit and scope of the disclosure will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

FIG. 1 illustrates the steps in a prior art process for electroplating ABS components.

FIG. 2 illustrates the steps in one embodiment of the inventive process.

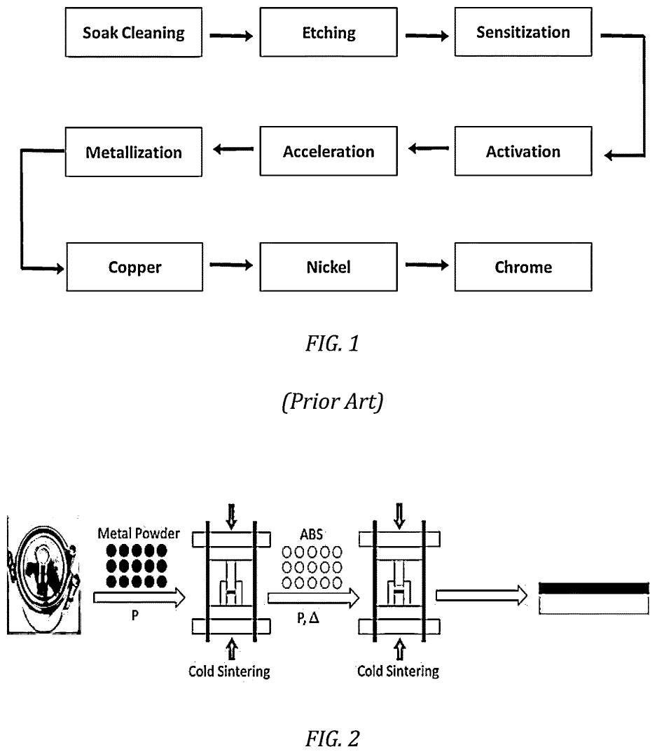

### DETAILED DESCRIPTION

The disclosure, is based, in part, on creating a continuous layer of metal particles on top of ABS plastic, using a cold sintering method. The metal layer can be made of such metals as Cu, Ni, Fe, or some combination of them. This continuous layer is then used as potential nucleation sites for an etchless plating purpose, to allow the plating of preferred metals to the surface, such as gold, silver, or chrome. Sintering is a process that consolidates particulate matter into compact solids through a diffusional process typically mediated by thermal energy to minimize the surface energy through the competitive processes of densification and coarsening. The concept of cold sintering involves the consolidation by plastic deformation of ductile metallic powders or salts. In cold sintering, the powder consolidation was achieved under high pressure at temperatures lower than the melting temperature of the material, where densities close to the theoretical can be achieved as a result of plastic deformation of powder particles and formation of strong interatomic bonds at the interfaces. Mainly this process includes sintering of inorganic particulates into a dense poly-crystalline ensemble in response to the thermal energy and/or pressure. This technology have been used in a wide range of applications such as electrochromic, ferroelectric, piezoelectric, Li-ion cathode, ceramic adhesive, and solid electrolytes.

This inventive process provides long list of benefits. The plastic component is activated during the molding using a cold sintering process. This thus creates an etchless plating process, with no use of CrO₃/H₂SO₄ acid for metallization, no usage of hazardous chemicals, in an environmentally friendly process. The inventive process also lowers the costs of plating, as well as reducing the effort, time and cost consumption, via the avoiding of etching, sensitization, activation and acceleration steps. The inventive process further replaces wet etching.

The following includes definitions of various terms and phrases used throughout this specification.

The terms “wt. %”, “vol. %” or “mol. %” refers to a weight, volume, or molar percentage of a component, respectively, based on the total weight, the total volume, or the total moles of the material that includes the component. In a non-limiting example, 10 moles of a component in 100 moles of the material means 10 mol % of the component. The term “M” refers to a molar concentration of a component, based on the moles per 1 L volume. The term “mM” means one thousandth of an “M”. Any numerical range used through this disclosure shall include all values and ranges there between unless specified otherwise. For example, a boiling point range of 50 °C to 100 °C includes all temperatures and ranges between 50 °C and 100 °C including the temperature of 50 °C and 100 °C.

The use of the words “a” or “an” when used in conjunction with the term “comprising,” “including,” “containing,” or “having” in the claims or the specification may mean “one,” but it is also consistent with the meaning of “one or more,” “at least one,” and “one or more than one.” The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The process of the present disclosure can “comprise”, “consist essentially of,” or “consist of” particular ingredients, components, compositions, etc., disclosed throughout the disclosure. With respect to the transitional phrase “consisting essentially of,” in one non-limiting aspect, a basic and novel characteristic of the compositions and methods of the present disclosure are their abilities to be used in electroless plating applications.

The details of the disclosure including the various embodiments of the disclosure is discussed in detail hereunder to enable a skilled artisan to appreciate the workings of the disclosure better.

For purposes of benchtop testing and evaluation, a hydraulic press was used, holding a pellet press die. Around this was wrapped a heating jacket to control the temperature of the contents of the mold, utilizing a temperature controller. It would be understood by a person of skill in the art how to expand to a larger scale for commercial purposes.

FIG. 2 illustrates the process of metal layer formation on ABS to enhance the surface etchless metallization. First, about 40 mg of the metal nano/micro particles powder are dispersed in the mold. Then, only pressure is applied for 30 min to form a thin compressed disc of the metal. After molding of the metal, about 160 mg of ABS powder is added to the same mold covering the metal disc and the annealing starts from room temperature up to 150 °C within 15 minutes. This temperature is maintained for about one hour under pressure. Finally, a continuous layer of metal that is coated on the molded ABS component provides active sites, which enhance the chemical plating without the need for any etching, sensitization, activation or acceleration steps. It would be understood by a person of skill in the art that the thickness of the metal nano/micro particles powder layer can be varied, along with the cold sintering time, the volume of ABS powder, and the time and heating and annealing time and temperatures, can all be varied as needed to generate the desired finished product.

While ABS is used in a preferred embodiment, one can work with numerous other plastics, including Acrylonitrile-Styrene-Butyl Acrylate (ASA) Blended into the plastic being used can be additives such as polycarbonate, styrene acrylonitrile (SAN), a thermal stabilizer, a metal releasing agent, an acid scavenger, an impact enhancer, or any combination thereof. Non-limiting examples of a thermal stabilizer can include a hindered phenol or phosphite stabilizer. Non-limiting examples of a metal releasing agent can include a metal stearate. Non-limiting examples of an acid scavenger can include a metal oxide. And, non-limiting examples of an impact enhancer can include a dimethyl siloxane polymer.

The polymer component can be used in a number industries, including automotive, consumer equipment, electronics, plumbing fixtures and electrostatic painting applications.

### EXAMPLES

Specific examples demonstrating some of the embodiments of the disclosure are included below. The examples are for illustrative purposes only and are not intended to limit the disclosure. It should be understood that the embodiments and the aspects disclosed herein are not mutually exclusive and such aspects and embodiments can be combined in any way. Those of ordinary skill in the art will readily recognize parameters that can be changed or modified to yield essentially the same results.

FIG. 2 illustrates the process of metal layer formation on ABS to enhance the surface etchless metallization. First, about 40 mg of the metal nano/micro particles powder are dispersed in the mold. Then, only pressure is applied for 30 min to form a thin compressed disc of the metal. After molding of the metal, about 160 mg of ABS powder is added to the same mold covering the metal disc and the annealing starts from room temperature up to 150 °C within 15 minutes. This temperature is maintained for about one hour under pressure. Finally, a continuous layer of metal that is coated on the molded ABS component provides active sites, which enhance the chemical plating without the need for any etching, sensitization, activation or acceleration steps. It would be understood by a person of skill in the art that the thickness of the metal nano/micro particles powder layer can be varied, along with the cold sintering time, the volume of ABS powder, and the time and heating and annealing time and temperatures, can all be varied as needed to generate the desired finished product.

An initial study has been carried out to demonstrate that the nucleation and subsequent presence of metal particles on the plastic surface enabled the chemical plating thus eliminating the etching step. This study was carried out to ensure that the plastic would be chemically plated and then electroplated after continuous metal layer formation.

In a typical experiment, ABS is directly coated with a metal layer during the molding step using the cold sintering technique. The pre-embedded metal layer acts as a conductive catalytic film that allows further deposition of metal on the plastic surface without any sensitizing and activating steps. The electroless plating is the step where the ABS substrate becomes conductive, so that the actual metal layer can be deposited during the electroplating. In this case, a conductive surface is achieved by the metal coating on the plastic via cold sintering. However, it was found that the conductivity of this coated metal layers depends on the choice of individual metal. Tests were conducted in which ABS samples had layers of Ni deposited on the surface. These samples demonstrated remarkable conductivity that enabled direct electroplating of the Cu on the ABS without need for the electroless step. However, the ABS samples that had layers of Fe or Ni/Fe showed less conductivity and required chemical plating first, followed by electroplating. As a comparison, chemical plating did not take place on the ABS samples that had a Cu layer. This pre-conductive surface allows skipping three consecutive plating steps compare to the incumbent wet etch process. Different metal selection gives different conductivity that may differ depending on chemical plating requirement.

While typical aspects have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

It will be apparent to those skilled in the art that various modifications and variations can be made in the present disclosure without departing from the scope or spirit of the disclosure. Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

The above description is intended to be illustrative, and not restrictive. For example, the above-described examples (or one or more aspects thereof) may be used in combination with each other. Other aspects can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed aspect. Thus, the following claims are hereby incorporated into the Detailed Description as examples or aspects, with each claim standing on its own as a separate aspect, and it is contemplated that such aspects can be combined with each other in various combinations or permutations. The scope of the disclosure should be determined with reference to the appended claims, along with the full scope of equivalents to which such claims are entitled.

1. A method of preparing a component suitable for metal plating, the method comprising:
(a) cold sintering metal powder to create a first portion of a component;
(b) adding plastic to at least one surface of the first portion, (c) cold sintering the plastic onto the first portion, the plastic being a second portion of the component.

2. The method of claim 1, wherein the shape of the first portion is defined by a mold.

3. The method of claim 1, wherein the plastic that is added is in a powdered form.

4. The method of claim 1, wherein the sintering steps are performed using a hydraulic press, a heat jacket and a temperature controller.

5. The method of claim 1, wherein the applied temperature is in the range of 140 to 200 °C, the time is in the range of 1 to 2 hours, and the pressure is in the range of 300 to 400 MPa.

6. The method of claim 1 1-5, wherein the powdered metal is primarily nickel, copper, iron, or a mixture thereof of two or more of nickel, copper and iron.

7. The method of claim 1, wherein the plastic is at least partially polycarbonate.

8. The method of claim 1, wherein the plastic is at least partially acrylonitrile butadiene styrene (ABS).

9. The method of claim 1, wherein the method does not include any additional binders.

10. The method of claim 1, further comprising an additional step of plating an additional metal onto the component, without etching, sensitization or activation steps.

11. The method of claim 10, wherein the additional metal is gold, silver, chrome, nickel, copper, nickel bright, copper bright, or mixture of them.

12. The method of claim 1, wherein the plastic includes thermal stabilizers.

13. The method of claim 1, wherein the plastic includes a lubricant or mold release.

14. The method of claim 1, wherein the plastic includes an acid scavenger.

15. The method of claim 1, wherein the plastic includes one or more impact enhancers.

16. A method of preparing a molded component suitable for metal plating, the method comprising:
creating a continuous layer of metal powder on top of a plastic by cold sintering, wherein the metal powder creates a first portion of the component by the cold sintering, wherein the shape of the first portion is defined by a mold, and wherein the plastic is a second portion of the component that is cold sintered onto the first portion, and wherein the plastic is at least partially polycarbonate and/or at least partially acrylonitrile butadiene styrene (ABS).
